(19) United States
(12) Patent Application Publication
(10) Pub. No.: US 2011/0173687 A1
(43) Pub. Date: Jul. 14, 2011

(54) Methods and Arrangements for an Internet Multimedia Subsystem (IMS)

(75) Inventors: Per Willars, Vaxholm (SE); Morgan Lindqvist, Sundbyberg (SE)

(73) Assignee: TELEFONAKTIEBOLAGET LM ERICSSON (PUBL), Stockholm (SE)

(21) Appl. No.: 13/119,523

(22) PCT Filed: Sep. 19, 2008
(86) PCT No.: PCT/EP08/62522

§ 371 Date: Mar. 17, 2011

(51) Int. Cl. G06F 7/04; H04L 12/66

(52) U.S. Cl. 726/7; 726/5; 370/352

(57) ABSTRACT

The present invention relates to provisioning of IMS parameters in an automated fashion. This is according to the present invention achieved by introducing a provisioning server providing an application, to be used on a user terminal, IMS parameters such that the application on the user terminal can utilize IMS services even if the user terminal is non-IMS capable or if the operator of the user has not deployed IMS. The provisioning of the IMS parameters may be triggered by a downloading of said application on the user terminal. Further, the application on the user terminal is configured with an address to the provisioning server in order to be able to send the request to the provisioning server.

### TECHNICAL FIELD

The present invention relates to methods and arrangements for an Internet Multimedia Subsystem (IMS) and in particular for providing IMS parameters required for utilizing IMS related services.

### BACKGROUND

Third Generation (3G) networks such as UMTS (Universal Telecommunication Network) provide high-speed wireless Internet access to mobile users over a wide coverage area. For the 3G networks the IP Multimedia Subsystem (IMS) has been defined to provide cellular access to the services of the Internet in order to support telephony and multimedia services. The IMS uses packet-based technology, in particular IP-network and other IETF protocols for provision of services. The strength of IMS is the provision of enhanced Services, for example multimedia services combining voice and data. Further, the usage of IP-network as a single underlying standard allows an easy and fast service deployment.

A Session Initiation Protocol (SIP) has been chosen in IMS for signalling between the user terminal and the IMS as well as between the components within the IMS. The IMS uses SIP also to complete voice and multimedia calls in the Internet. In order to be able to use the IMS service, the communicating user's equipment has to support IMS and the operator of the user has to be able to provide IMS functionalities in the operator's network in accordance with the IMS standard specifications.

In the following simplified network architectures of IMS is described in conjunction with FIG. 1. The IMS can be considered to be a part of the core network and a mobile terminal 101 also referred to as a user terminal accesses the IMS via its access network 102, e.g. a 3G network.

Public and private IMS identities and the MSISDN are stored in the HSS (Home Subscriber Server) 104 shown in FIG. 1 that is the master user database supporting the IMS network entities that are actually handling the calls/sessions. Further, the HSS contains the subscription-related information (user profiles), performs authentication and authorization of the user, and can provide information about the physical location of user.

The IMS network comprises a plurality of SIP servers and SIP proxies called CSCF (Call Session Control Function), used to process the SIP signaling packets in the IMS.

A P-CSCF (Proxy-CSCF) 103 is a SIP proxy that is the first point of contact for the IMS terminal. An I-CSCF (Interrogating-CSCF) 108 is a SIP proxy located at the edge of an administrative domain. Its IP address is published in the DNS of the domain, so that remote servers (e.g., a P-CSCF in a visited domain, or a S-CSCF in a foreign domain) can find it, and use it as an entry point for all SIP packets to this domain. The I-CSCF queries the HSS 104 to retrieve the user location, and then routes the SIP request to its assigned S-CSCF 105.

An S-CSCF (Serving-CSCF) 105 is the central node of the signaling plane. The S-CSCF 105 downloads and uploads user profiles from the HSS 104 since it has no local storage of the user.

Application servers (AS) 106 host and execute services, and interface with the S-CSCF using SIP. This allows third party providers an easy integration and deployment of their value added services to the IMS infrastructure.

The MGW 112 (Multimedia Gateway) and its control function MGCF (Media Gateway Control Function) supports transcoding of the media and transport interworking. Further, the MRF (Media Resource Function) 207 provides a source of media in the home network. It is e.g. used for multimedia conferencing. The I-BGF 210 shown in FIG. 2 is the border gateway function that is controlled by the I-BCF 109.

As already mentioned, the UMTS system allows mobiles operating in packet mode to establish voice calls using SIP as the signalling protocol. The SIP messages are sent to communicate the request to the Call Session Control Function (CSCF) in the IMS. In this case, the data is transmitted as packets throughout the UMTS network. However in order to access any service in IMS the user has to perform a registration procedure in the IMS system.

Said registration procedure is performed by means of an IMS stack being implemented in the user's equipment.

Thus, the IMS has been deployed for the 3G networks for provision of services using packet-based technology with SIP as applied signalling protocol. However, currently the major number of user's equipment do not support IMS technology, either since the terminal and the subscription are not IMS enabled or since the operator's network does not support IMS. In order to be able to access IMS services the user must be provisioned with an IMS capable SIM from its operator, whereby the operator acts as an IMS provider, and the terminals must be provided with a built-in IMS stack. The terminals register to the IMS network and access the SIM to authenticate themselves to the IMS network.

For communication services such as those offered by IMS, it is important to be able to reach other users. For early adopters of IMS (i.e. operators deploying IMS and users buying IMS capable terminals) there are two main problems to solve to enable reaching several other users:

1. Reaching users in networks which have not deployed IMS.
2. Reaching users with terminal that are not IMS capable.

One solution to the first problem is that an actor sets up a public IMS network, accessible over the Internet which can act as an IMS provider for all users whose operators have not deployed IMS. This is referred to as a “standalone” IMS network or a “hosted IMS”.

One solution to the second problem is that the IMS provider (mobile operator or standalone IMS network provider) provides a set of Java libraries that implement the IMS stack to the application developers. These can be included in the Java applications that are downloaded by users to non-IMS terminals, thus providing at least a subset of IMS functions also to non-IMS terminals.

The main problem is however, that current IMS standards, in particular for mobile access, do assume that the IMS provider is also the provider of the SIM (or at least has a strong trust relation to the SIM provider). Thus, a standalone IMS network (i.e. the provider thereof) cannot authenticate its users using SIM-based methods. Further, a Java application, even if including a Java stack, cannot support SIM based (AKA) authentication on a non-IMS terminal.

The mainstream alternative method for authentication is “SIP digest”, in which the client is provisioned with authentication secrets (username+password) from the IMS provider. At IMS registration, there is a challenge-response transaction to authenticate the client. (For subsequent authentications, the IMS provider can either set up a security association (e.g. TLS or IPsec) to the client, or repeat the challenge-response authentication for each SIP transaction, or provision the IP address from which the signalling is received as a trusted node.

Besides the authentication parameters, there is also a need to provision the public identity of a new IMS user. The state-of-art solutions have the following problems: There is no clear way to automate the provisioning of IMS identities and authentication parameters. Further, even if there would be a solution working for a single provider, there is no solution how a client can get provisioned from the serving operator, if that is the IMS provider, and otherwise from a standalone IMS provider.

Application developers may make one version for IMS terminals, and one for non-IMS terminals, since it is possible at download time of the application to detect IMS support by the terminal, e.g. by means of UAProf (User Agent profile), wurfl (Wireless Universal Resource File). However, it is difficult for application developers to make different variants depending on whether the operator is IMS provider or not. Accordingly, the same application must work in operator IMS provider and in standalone IMS provider cases.

### SUMMARY

Hence, the objective problem of the present invention is to enable provisioning of IMS parameters in an automated fashion.

This is achieved by introducing a provisioning server providing an application to be used on a user terminal IMS parameters such that the application on the user terminal can utilize IMS services even if the user terminal is non-IMS capable or if the operator of the user has not deployed IMS. The provisioning of the IMS parameters may be triggered by a downloading of said application on the user terminal. Further, the application on the user terminal is configured with an address to the provisioning server in order to be able to send the request to the provisioning server.

According to a first aspect the present invention relates to a method for a provisioning server for providing IMS parameters to a user terminal. The IMS parameters are, required for registration to an IMS. In the method, a first request, comprising a phone number associated with the user terminal, for IMS parameter from an application stored on the user terminal, is received. Determination may then be performed whether the user needs to be authenticated. If it is determined that the user needs to be authenticated, the steps of sending, in response to said request, a first password to the application stored on the user terminal using the phone number of the request, and receiving a request, comprising the first password, for IMS parameters from said application to authenticate the user, are performed. When authentication is completed, provided that authentication is required, the method comprises the further steps of sending a second request for IMS parameters to the IMS, receiving the IMS parameters from the IMS and sending the received IMS parameters to the application stored on the user terminal such that the user terminal can register to the IMS.

According to a second aspect of the present invention a method for an application in a user terminal for retrieving IMS parameters, required for registration to an IMS is provided. The user terminal is configured with an address to a provisioning server. A phone number of the SIM associated with the user terminal is received, a first request for IMS parameters from an application stored on the user terminal is sent to the provisioning server. The request comprises the phone number associated with the user terminal. In response to said request a first password may be received if the user needs to be authenticated. A second request comprising the first password for IMS parameters from the application to the provisioning server is then sent, and the requested IMS parameters are received at the application.

According to third aspect of the present invention an application to be used in the user terminal is provided. The application is configured with an address to a provisioning server. The application comprises a first receiver for receiving a phone number of the SIM associated with the user terminal and a sender for sending a first request for IMS parameters from an application stored on the user terminal to the provisioning server. The first request comprises the phone number associated with the user terminal. The application may further comprise a second receiver for receiving, in response to said request, a first password if the user needs to be authenticated, wherein the sender is further configured to send a second request comprising the first password for IMS parameters from the application to the provisioning server. Moreover, the second receiver is further configured to receive the requested IMS parameters.

According to a fourth aspect of the present invention a provisioning server for providing IMS parameters required for registration to an IMS to a user terminal is provided. The provisioning server comprises a receiver for receiving a first request wherein the first request for IMS parameter from an application stored on the user terminal. The request comprises a phone number associated with the user terminal. The provisioning server may further comprise determining means for determining whether the user needs to be authenticated. If authentication is required, a first sender sends a first password to the application stored on the user terminal using the phone number of the request. The first receiver is further configured to receive a request for IMS parameters from said application, comprising the first password such that the provisioning server can authenticate the user. A second sender is configured to send a second request for IMS parameters to the IMS core when the user is authenticated. Further, a second receiver is configured to receive the IMS parameters from the IMS and wherein the first sender is further configured to send the received IMS parameters to the application stored on the user terminal such that the user terminal can register to the IMS.

An advantage with embodiments of the present invention is that IMS applications can be provisioned with identities and authentication information automatically when installed on IMS terminals. In particular, the invention provides one and the same method to provision this information, regardless of whether it is the operator's network or a standalone IMS network that provides the information. This results in that it is possible to rollout IMS applications also to non-IMS terminals without needing to know whether the users' current network operator provides IMS services or not.

### BRIEF DESCRIPTION OF THE DRAWINGS

FIG. 1 illustrates schematically a mobile telecommunication network with an IMS according to prior art.

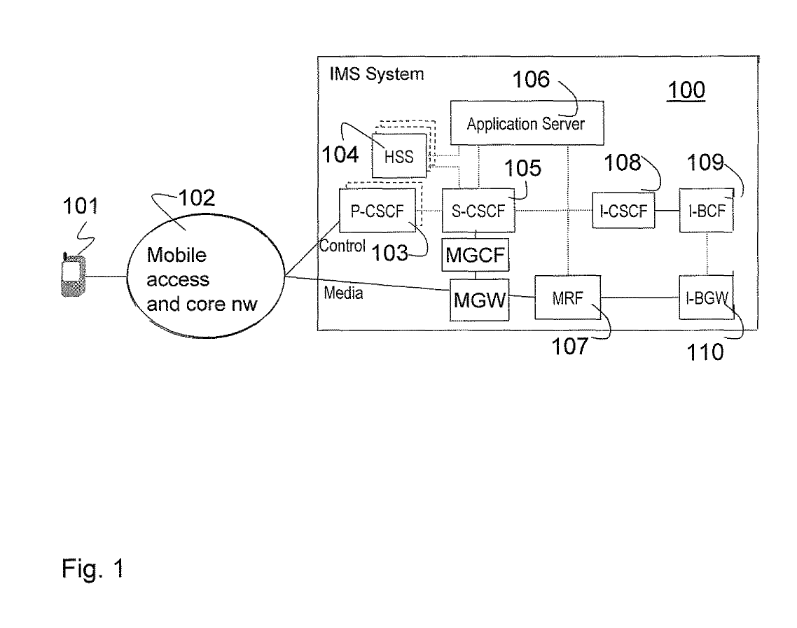

FIG. 2 illustrates a sequence diagram of embodiments of the present invention.

FIG. 3 illustrates a scenario applicable for embodiments of the present invention.

FIG. 4 is a sequence diagram showing the sequences when the operator of the user has not deployed IMS and the provisioning server of the standalone IMS network is required for IMS parameter provisioning.

FIG. 5 is a sequence diagram showing the case when the operator of the user has deployed IMS

FIG. 6 illustrates schematically a user terminal and a provisioning server according to embodiments of the present invention.

### DETAILED DESCRIPTION

In the following, the invention will be described in more detail with reference to certain embodiments and to accompanying drawings. For purposes of explanation and not limitation, specific details are set forth, such as particular scenarios, techniques, etc., in order to provide a thorough understanding of the present invention. However, it will be apparent to one skilled in the art that the present invention may be practised in other embodiments that depart from these specific details.

Moreover, those skilled in the art will appreciate that the functions and means explained herein below may be implemented using software functioning in conjunction with a programmed microprocessor or general purpose computer, and/or using an application specific integrated circuit (ASIC). It will also be appreciated that while the current invention is primarily described in the form of methods and devices, the invention may also be embodied in a computer program product as well as in a system comprising a computer processor and a memory coupled to the processor, wherein the memory is encoded with one or more programs that may perform the functions disclosed herein.

The present invention makes it possible to provision IMS parameters, required to access an IMS, in an automated fashion. The provisioning may be triggered by the user downloading and starting an application to the user terminal, wherein the application requires IMS capabilities.

This is according to the present invention achieved by introducing a provisioning server. The application requiring IMS capabilities is provided with the address of the provisioning server.

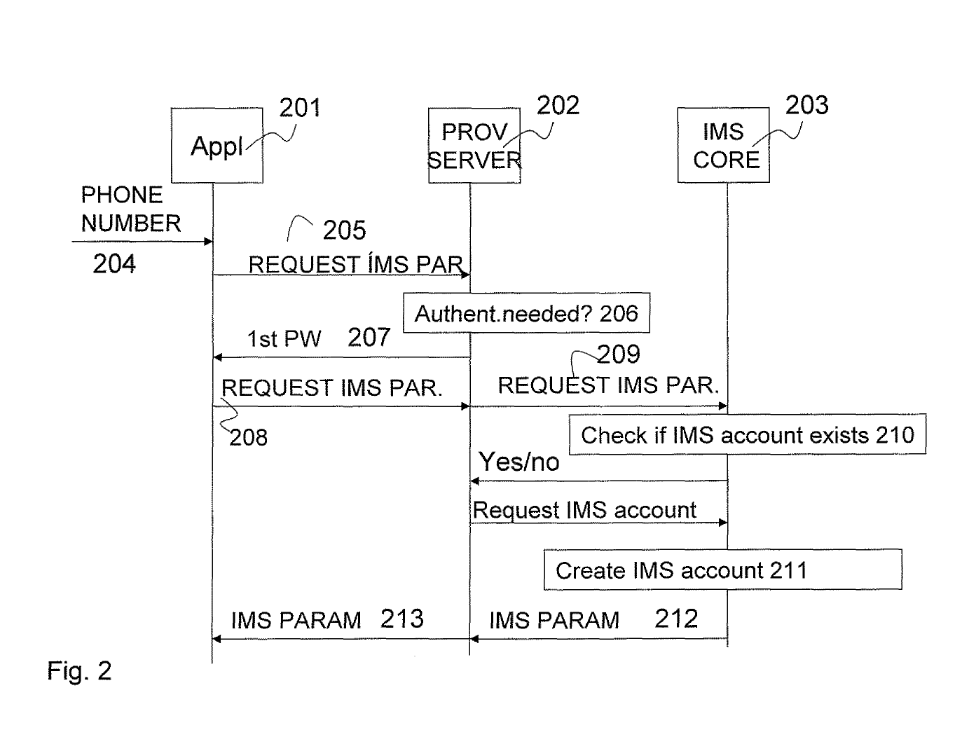

Turning now to FIG. 2 showing a sequence diagram of the IMS parameter provisioning according to embodiments of the present invention.

Initially, the user terminal downloads and starts an application 201 requiring IMS. At step 204, the user enters on request from the application the phone number associated with the user terminal. The application 201 sends a request for IMS parameters to the provisioning server 202 at step 205. This request comprises the entered phone number and the application 201 is configured with the address of the provisioning server. The provisioning server 202 may be a server in the operator's network of the user if the operator is an IMS provider, otherwise the provisioning server may be a part of a standalone IMS network. If the server is a part of a standalone IMS network, the address of the provisioning server may be resolved via public Internet DNS (Domain Name Server). When the provisioning server has received the request in step 205 it checks 206 whether the user is authenticated. If the user is not authenticated, the provisioning server sends 207 in response to said request 205, the first password to the application of the user terminal by means of the phone number included in the request 205. The first password may be sent via SMS and the first password may be a one time password. If SMS is used, the request 205 may comprise a name of a port on which the application is listening for incoming SMS. It should be noted that other means for carrying the password also may be used such as Instant Messaging (IM) and Multimedia Messaging Service (MMS).

The first password is used to authenticate 206 the user terminal according to embodiments of the present invention. Hence the provisioning server 202 may authenticate 206 the user terminal by verifying that the first password received from the application of the user terminal is identical to the first password sent from the provisioning server in the previous step 207.

When the application 201 has received the first password it sends a further request 208 for IMS parameters to the provisioning server 202. The first password is included in this request 208.

If the user already is authenticated, steps 207 and 208 are omitted.

When the user terminal is authenticated by the provisioning server, either by performing steps 207 and 208 or if the user already is authenticated at step 206, the provisioning server 202 requests 209 the IMS parameters for this phone number.

If no IMS parameters exist for that phone number, the provisioning server 202 sends a request to the EMA node in the IMS core 203 to create a new IMS account and an IMS account and IMS parameters are created 211 at the IMS core. In the response to the request the EMA node in the IMS core 203 sends 212 the IMS parameters to the provisioning server 202. The provisioning server 202 forwards 213 the IMS parameters to the user terminal in the response to the request 208, 205 for IMS parameters.

If IMS parameters already exist for that phone number step 211 is omitted, and the IMS core 203 sends 212 the IMS parameters to the provisioning server 202. Accordingly, the provisioning server 202 forwards 213 the IMS parameters to the user terminal in the response to the request 208, 205 for IMS parameters

The IMS parameters may be a public IMS user identity, private IMS identity, a second password, IMS realm, and IP addresses to the P-CSCF and to the AP in the IMS core.

Hence the application 201 can connect to the IMS and use applications and services requiring IMS capability when the application 201 of the user terminal has received the requested IMS parameters. Examples of such services may be Presence, Messaging and file transfer.

As stated above, the application, e.g. a Java MIDlet, downloaded on the user terminal must be aware of the address to the provisioning server. That can be achieved in many ways.

Each application installed on a non-IMS capable terminal may include an IMS stack and a provisioning service library. The provisioning service library may be configured with a FQDN (Fully Qualified Domain Name) for a provisioning server, e.g. “imsprovisioning.com”. The application contacts this provisioning server when started the first time to get the IMS parameters.

Each application installed on an IMS terminal is configured with the same FQDN for a provisioning server e.g. “imsprovisioning.com”. The application checks with the built-in IMS stack whether it already has received the IMS parameters. If no IMS parameter is available, then the application will trigger the provisioning service from the included provisioning service library, i.e. with a request for the IMS parameters.

The actual IMS registration is performed either by the built-in IMS stack (if that is allowed to be configured with IMS parameters) or by an IMS stack included in the downloaded application (as for the case with the non-IMS terminal).

When the terminal is in a network where the operator does not provide IMS, the request to “imsprovisioning.com” will be resolved by a public DNS on the Internet. The provider of the standalone IMS network may have registered “imsprovisioning.com” to be directed to its provisioning server, and thus the standalone IMS network will become the IMS provider for the user terminal in this case.

When the terminal is located in a network where the operator provides IMS, the operator's network will resolve “improvisioning.com” to the operator's own provisioning server.

The provisioning server will then provide the IMS parameters e.g. including the user identity and the SIP digest password to the application on the user terminal. Furthermore, it should be noted that the address “improvisioning.com” used throughout the specification only is an example.

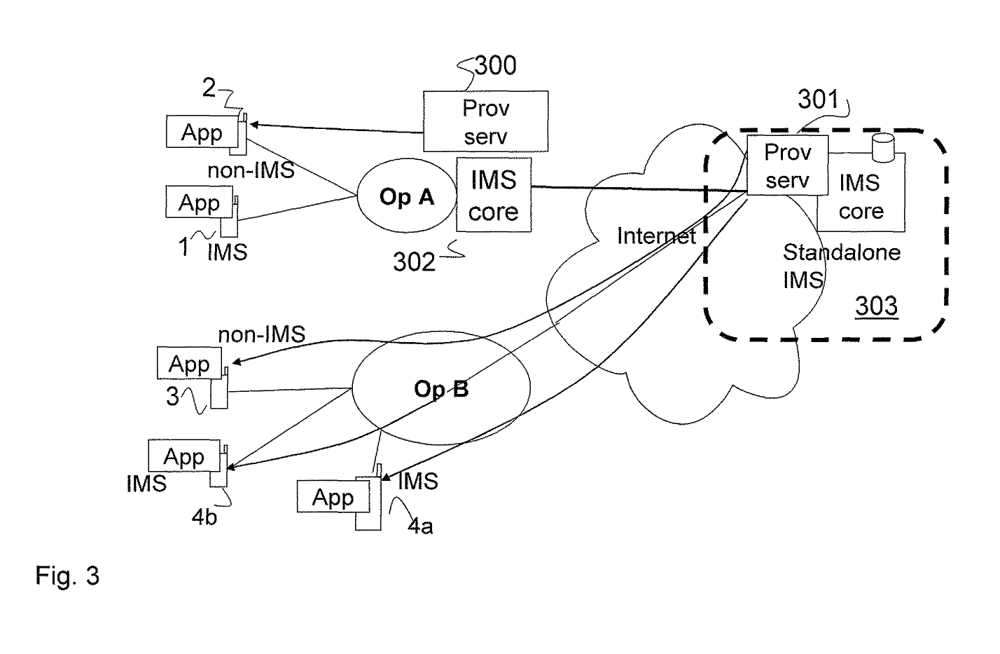

Turning now to FIG. 3 showing a scenario to further explain embodiments of the present invention. The scenario of FIG. 3 comprises terminal 1 and 2 connected to Operator A Op A which has deployed IMS 302. The scenario further comprises terminal 3, 4a and 4b which are connected to Operator B Op B which has not deployed IMS. Terminal 1 is an IMS terminal and uses SIM-based authentication, which implies that terminal 1 does not need the provisioning server 300 for obtaining the IMS parameters. Terminal 2 is a non-IMS terminal and is provisioned with IMS parameters from the provisioning server 300 in the operator's Op A network.

Further, the terminal 3 is a non-IMS terminal provisioned with IMS parameters from the provisioning server 301 in the standalone IMS network 303. The terminal 4a is an IMS terminal provisioned from the provisioning server 301 in the standalone IMS network 303. The built-in IMS stack of the terminal 4a is accessible for provisioning of digest authentication. Finally, terminal 4b is an IMS terminal provisioned from the provisioning server in the standalone IMS network. The built-in IMS stack is not accessible for provisioning of digest authentication, which implies that the IMS stack in the downloaded application must be used and is the target for provisioning of IMS parameters according to the present invention.

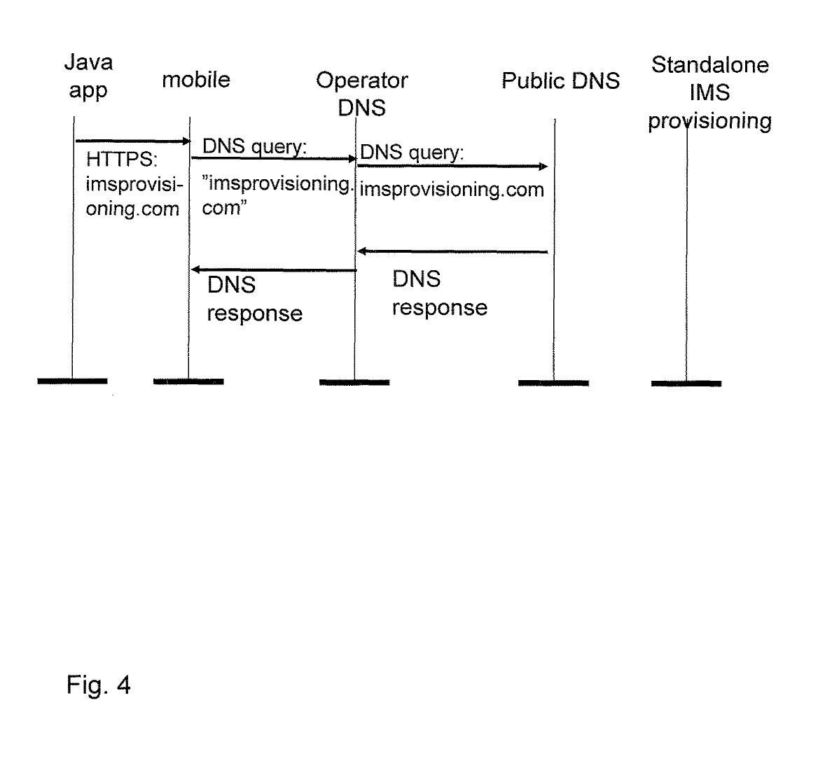

FIG. 4 is a signalling diagram showing the sequences when the operator of the user has not deployed IMS and the provisioning server of the standalone IMS network is required for IMS parameter provisioning. In this case, the URL imsprovisioning.com is resolved by a public DNS to the provisioning server of the standalone IMS network.

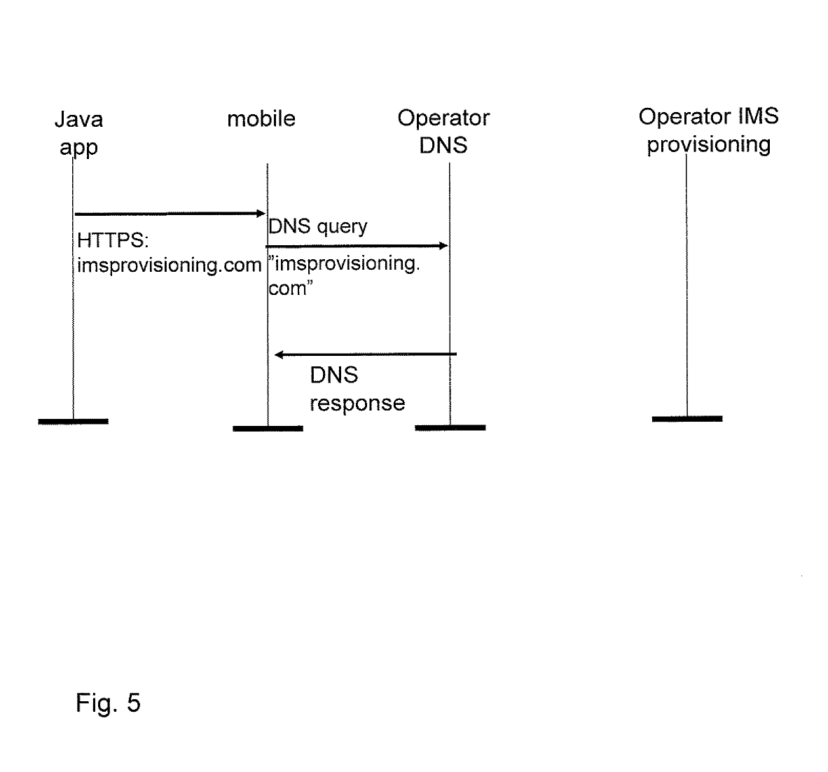

FIG. 5 is a signalling diagram when the operator of the user has deployed IMS. In this case, the URL imsprovisioning.com is resolved by the operator's DNS to the provisioning server of the operator.

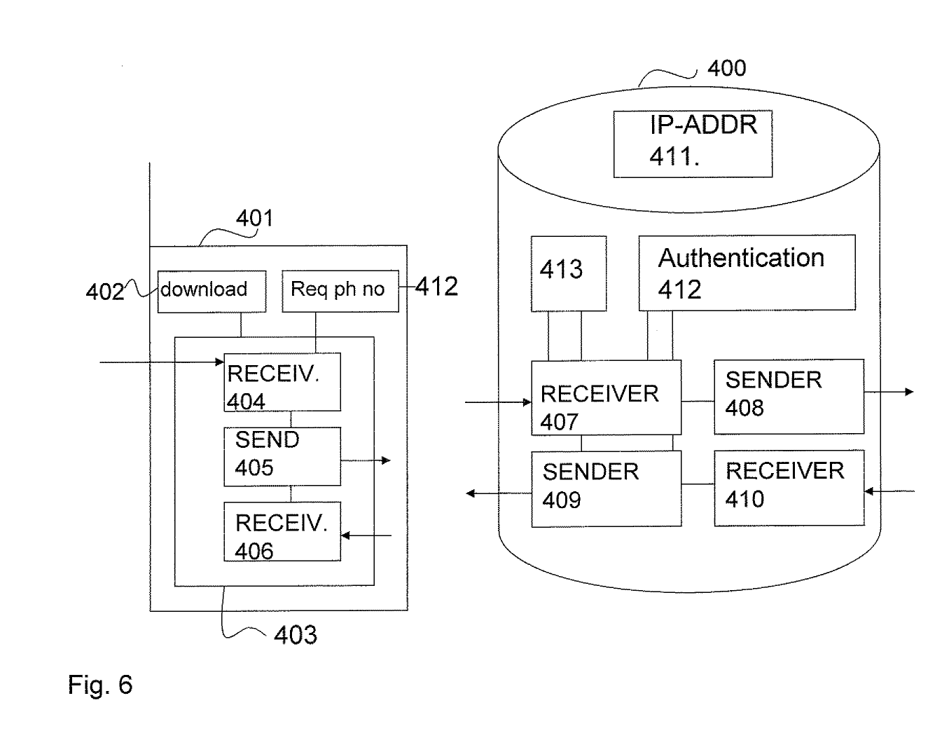

Moreover, embodiments of the present invention concern an application for a user terminal and a provisioning server. As illustrated in FIG. 6, an application to be used in the user terminal is configured with an address 411 to a provisioning server. The application comprises a first receiver 404 for receiving a phone number of the SIM associated with the user terminal and a sender 405 for sending a first request for IMS parameters from an application stored on the user terminal to the provisioning server. The first request comprises the phone number associated with the user terminal. The application further comprises a second receiver 406 for receiving, in response to said request, a first password if the user needs to be authenticated, wherein the sender 405 is further configured to send a second request comprising the first password for IMS parameters from the application to the provisioning server. Moreover, the second receiver is further configured to receive the requested IMS parameters.

In order to be able to include the phone number in the request, the application comprises according to one embodiment means for requesting a user to enter the phone number and means for receiving the phone number, which is entered by the user. The request for IMS parameters may be triggered by the application downloads and starts the application, therefore the application may comprise means for downloading and starting the application, and a memory for storing the application. The application may be a JAVA MIDlet.

The application may be implemented by a computer program product, which is directly loadable into the internal memory of a digital computer, comprising software code portions for performing the steps described in conjunction with FIG. 2. The computer program product may be stored on a computer usable medium comprising computer readable program means for causing a computer to control an execution of the application.

As stated above, embodiments of the present invention also concerns a provisioning server for providing IMS parameters required for registration to an IMS to a user terminal. The provisioning server comprises a receiver 407 for receiving a first request wherein the first request for IMS parameter from an application stored on the user terminal. The request comprises a phone number associated with the user terminal. The provisioning server further comprises determining means 413 for determining whether the user needs to be authenticated. If authentication is required, a first sender 409 sends a first password to the application stored on the user terminal using the phone number of the request. The first receiver 407 is further configured to receive a request for IMS parameters from said application, comprising the first password such that the provisioning server can authenticate the user. A second sender 408 is configured to send a second request for IMS parameters to the IMS core when the user is authenticated. Further, a second receiver 410 is configured to receive the IMS parameters from the IMS and wherein the first sender 409 is further configured to send the received IMS parameters to the application stored on the user terminal such that the user terminal can register to the IMS.

Thus, the provisioning server comprises according to one embodiment an authenticator for authenticating the user terminal by verifying that the first password received from the application of the user terminal is identical to the first password sent from the provisioning server in a previous step. The first sender sending the first password to the application stored on the user terminal using the phone number of the request may use an SMS (short message service) message for the transmission. The first password may be a one time password and the IMS parameters may comprise at least a public IMS user identity and a second password.

The above mentioned and described embodiments are only given as examples and should not be limiting to the present invention. Other solutions, uses, objectives, and functions within the scope of the invention as claimed in the accompanying patent claims should be apparent for the person skilled in the art.

1-20. (canceled)

21. A method in a provisioning server for providing to a user terminal IMS parameters required for registration with an Internet Multimedia subsystem, IMS, the method comprising:
receiving a first request for IMS parameters from an application downloaded and started by the user terminal and configured with an address of the provisioning server, wherein the first request includes a phone number that is associated with the user terminal and that is entered by a user on request from the application,
sending a second request for IMS parameters to the IMS,
receiving the IMS parameters from the IMS, and
sending the received IMS parameters to the application for registration by the user terminal with the IMS.

22. The method according to claim 21, further comprising:
determining, responsive to receiving the first request, whether the user terminal needs to be authenticated, and
if it is determined that the user terminal needs to be authenticated:
sending, in response to the first request, a first password to the application using the phone number included in the first request; and
receiving a third request for IMS parameters from said application, to authenticate the user terminal, the third request comprising the first password.

23. The method according to claim 22, further comprising:
authenticating the user terminal by verifying that the first password received from the application is identical to the first password sent from the provisioning server.

24. The method according to claim 22, wherein the sending of the first password to the application comprises sending the first password using a short message service, Instant Messaging, or Multimedia Messaging Service.

25. The method according to claim 22, wherein the first password is a one time password.

26. The method according to claim 21, wherein the IMS parameters comprise at least a public IMS user identity and a second password.

27. A method implemented by a user terminal for retrieving IMS parameters required for registration with an Internet Multimedia subsystem, IMS, wherein the method comprises:
downloading and starting an application requiring IMS, wherein the application is configured with an address to a provisioning server,
requesting a user to enter a phone number associated with the user terminal,
receiving the phone number associated with the user terminal as entered by the user,
sending a first request for IMS parameters to the provisioning server using the address configured in the application, the first request including the phone number entered by the user, and
receiving the requested IMS parameters.

28. The method according to claim 27, further comprising:
receiving a first password in response to said first request, if the user terminal needs to be authenticated, and
sending a second request for IMS parameters to the provisioning server, the second request comprising the first password.

29. The method according to claim 27, wherein the application is a JAVA MIDlet.

30. A provisioning server for providing to a user terminal IMS parameters required for registration with an Internet Multimedia subsystem, IMS, the provisioning server comprising:
a first receiver configured to receive a first request for IMS parameter from an application downloaded and started by the user terminal and configured with an address of the provisioning server, wherein the first request includes a phone number that is associated with the user terminal and that is entered by a user on request from the application,
a second sender configured to send a second request for IMS parameters to the IMS,
a second receiver configured to receive the IMS parameters from the IMS, and
a first sender configured to send the received IMS parameters to the application for registration by the user terminal with the IMS.

31. The provisioning server according to claim 30, wherein the provisioning server is configured to determine whether the user terminal needs to be authenticated, and wherein the first sender is further configured to send, in response to said first request, a first password to the application using the phone number included in the first request, if it is determined that the user terminal needs to be authenticated, and wherein the first receiver is further configured to receive a third request for IMS parameters from said application, to authenticate the user terminal, the third request including the first password.

32. The provisioning server according to claim 31, wherein the provisioning server further comprises an authenticator configured to authenticate the user terminal by verifying that the first password received from the application is identical to the first password sent from the provisioning server.

33. The provisioning server according to claim 30, wherein the first sender is configured to send the first password using a short message service, Instant Messaging, or Multimedia Messaging Service.

34. The provisioning server according to claim 30, wherein the first password is a one time password.

35. The provisioning server according to claim 30, wherein the IMS parameters comprise at least a public IMS user identity and a second password.

36. A user terminal configured to retrieve IMS parameters required for registration with an Internet Multimedia subsystem IMS, wherein the user terminal is configured to:
download, store in memory, and start an application that is configured with an address to a provisioning server and that, when started, requests a user to enter a phone number associated with the user terminal
receive a phone number associated with the user terminal as entered by the user,
send a first request for IMS parameters to the provisioning server, the first request including the phone number entered by the user, and
receive the requested IMS parameters.

37. The user terminal according to claim 36, further configured to receive, in response to said first request, a first password, if the user terminal needs to be authenticated, and to send a second request for IMS parameters to the provisioning server, to authenticate the user terminal, the second request including the first password.

38. The user terminal according to claim 36, wherein the application is a JAVA MIDlet.

39. A computer program product stored in memory at a user terminal and comprising computer program code corresponding to an application that, when executed by a processor at the user terminal, cause the user terminal to retrieve IMS parameters required for registration with an Internet Multimedia subsystem, IMS, the computer program code causing the user terminal to:
request a user to enter a phone number associated with the user terminal,
receive a phone number associated with the user terminal, as entered by the user,
send a first request for IMS parameters to a provisioning server identified by an address configured within the computer program code, the first request including the phone number entered by the user, and
receive the requested IMS parameters.

40. The computer program product according to claim 39, the computer program code further causing the user terminal to receive, in response to said first request, a first password, if the user terminal needs to be authenticated, and to send a second request for IMS parameters to the provisioning server, to authenticate the user terminal, the second request including the first password.
